(19) United States
(12) Patent Application Publication
(10) Pub. No.: US 2009/0032184 A1
(43) Pub. Date: Feb. 5, 2009

(54) Resistance Welding of Thermoplastics

(76) Inventors: Ali Yousefpour, Montreal (CA); Marc-Andre Octeau, Montreal (CA)

Correspondence Address: GEORGE A. SEABY;SEABY & ASSOCIATES, 250 CITY CENTRE AVNUE, OTTAWA, ON, K1R6K7, CA

(21) Appl. No.: 11/887,847

(22) PCT Filed: Apr. 8, 2005
(86) PCT No.: PCT/CA2005/000529

§ 371 Date: Oct. 4, 2007

(51) Int. Cl. B29C 65/18

(52) U.S. Cl. 156/275.1; 156/543

(57) ABSTRACT

Articles containing thermoplastic material are welded together by placing a heating element between an overlapping side edges of the articles to define a weld area between the overlapping side edges with the heating element extending outwardly therebeyond, effecting relative movement between electrodes in contact with the exposed sides of the heating element and the articles while applying current to the electrodes to create a moving localized melt zone, and applying pressure to the melt zone immediately following creation of the zone to fuse the articles to each other and to the heating element.

This invention relates to a method and an apparatus for continuously welding thermoplastic materials and in particular thermoplastic polymer composites.

Advanced thermoplastic composites are widely used, particularly in the aerospace industry. As the use of such composites has increased, the need for effective and reliable methods for joining the composites has continued to grow. Traditional methods of joining thermoplastic composite parts include adhesive bonding and mechanical fastening, both of which are tedious, labor intensive and costly. Extensive surface preparation, long curing times of adhesives and poor bonding properties between adhesives and the thermoplastic polymers make adhesive bonding undesirable. Mechanical fastening methods suffer from problems arising from stress concentration, galvanic corrosion, mismatch of coefficient of thermal expansion and damage to reinforcing fibers induced by drilling.

In the recent past, thermoplastic composite materials have been fusion bonded by induction welding, ultrasonic welding and, to a limited extent, by resistance welding. Resistance welding has been identified as a promising technique among various fusion bonding methods. Resistance welding is based on the principle of placing a layer of conductive material called a heating element between the surfaces of the parts to be joined. An electrical current is applied to the heating element to increase the temperature thereof as a result of resistance heating. The heat causes the surrounding thermoplastic polymer to melt. Under the application of pressure, molecular diffusion occurs at the interface and when the joint is cooled the polymer solidifies resulting in a weld. Resistance welding of small pieces, e.g. lap welding of coupon size pieces is a fast process with short welding times ranging from 1 to 5 minutes with little to no surface preparation. In addition, the welding equipment is simple and inexpensive and can be made portable for repair purposes.

However, resistance welding has not been fully developed for a variety of reasons including (i) non-repeatability and inconsistent performance of welded parts, (ii) pressure and power limitations for welding large parts, (iii) problems relating to preferential and local heating in weld areas, and (iv) the amount of time to produce a weld between large thermoplastic parts.

For example, U.S. Pat. No. 5,313,034 to Grimm et al teaches a process for producing long, continuous, thermoplastic welds between large structures. A series of tabs are used in pairs, and especially in alternating, overlapping pairs to effect resistance heating of a strip of material placed in a bond line. The resistance of the tabs is less than that of the strip of material. A continuous weld is produced by clamping electrodes to pairs of tabs and applying voltage and pressure. After the first weld cools, another section of the weld is made using a second pair of tabs to produce a weld overlapping the first weld. It will be appreciated that producing a continuous weld by this method is a much more lengthy procedure than the production of the same weld using a single heating and cooling operation.

It is readily apparent that a need exists for a workable system for resistance welding of thermoplastic composite materials.

An object of the present invention is to meet the above defined need by providing a relatively simple apparatus and method for continuously welding thermoplastic materials.

According to one aspect the invention relates to an apparatus for resistance welding of two thermoplastic articles comprising:

a support for supporting the articles in overlapping relationship;

a resistance heating element for positioning between said articles in an area of overlap along a length to be welded, said heating element having a width sufficient to span a weld area and extend outwardly beyond the area of overlap providing two exposed side edges of the heating element;

electrodes for connection to respective ones of said two side edges of said heating element;

a compactor for pressing said articles together in said weld area following melting of the articles to effect welding of the articles; and

a drive for moving at least one said electrode and compactor in synchronism relative to said articles along said weld area with said compactor behind at least one said electrode,

whereby said articles are pressed together in said weld area following melting of the articles to effect welding of the articles.

According to another aspect, the invention relates to a method of resistance welding two thermoplastic articles comprising the steps of:

placing a heating element between an overlapping area of said articles to define a weld area between overlapping side edges of the articles with the heating element extending outwardly beyond said side edges;

effecting relative movement between electrodes in contact with said heating element and the articles while applying current to the electrodes to effect localized heating of the weld area sufficient to create a moving, localized melt zone; and

applying pressure to said articles in the localized melt zone of the weld area immediately following creation of said localized melt zone to fuse the articles together.

The invention is described below in greater detail with reference to the accompanying drawings, wherein:

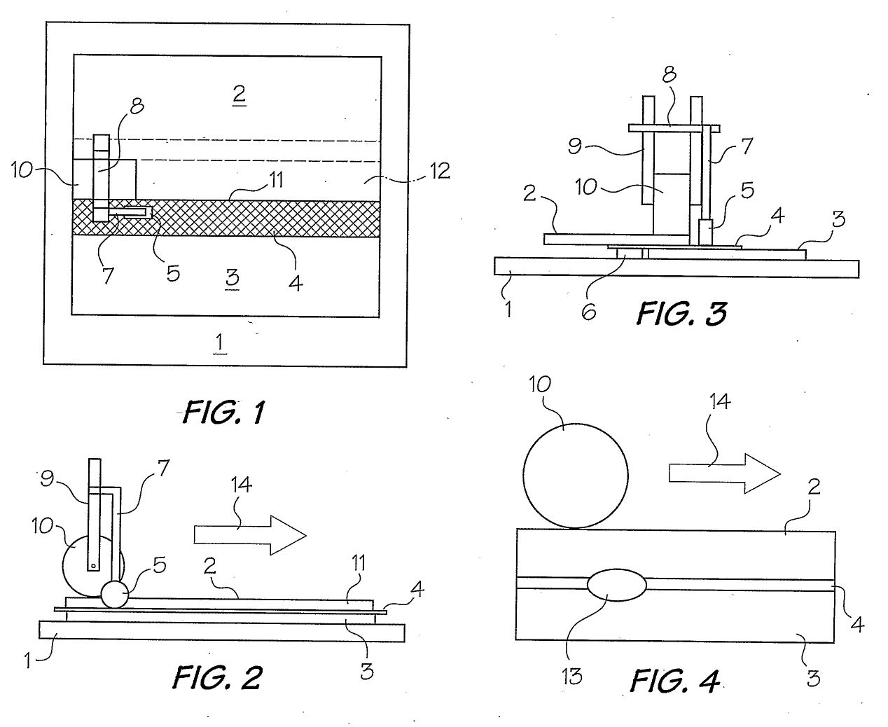

FIG. 1 is a schematic top view of an apparatus for resistance welding of two layers of thermoplastic composite material;

FIG. 2 is a schematic side view of the apparatus of FIG. 1;

FIG. 3 is a schematic end view of the apparatus of FIG. 1;

FIG. 4 is a schematic sectional view of the two layers during a welding operation;

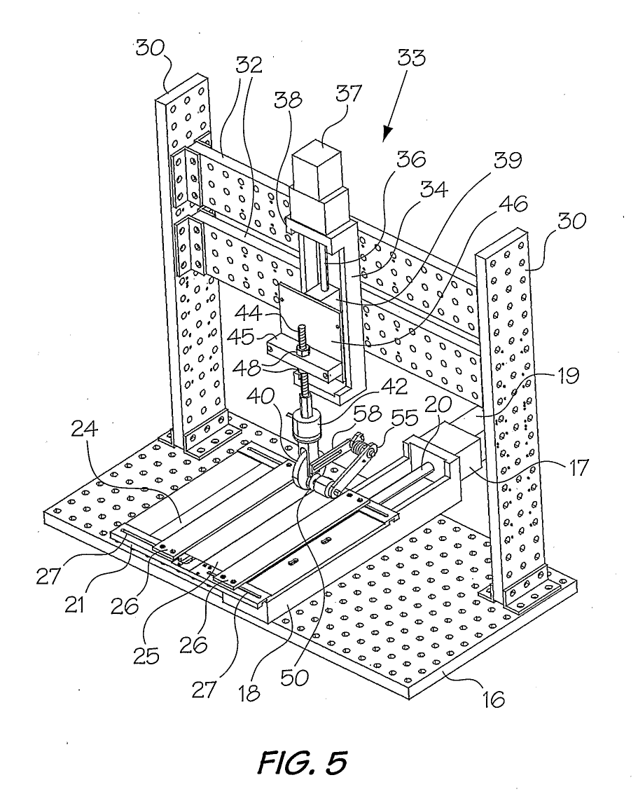

FIG. 5 is an isometric view of a second embodiment of the apparatus of the present invention as seen from one side;

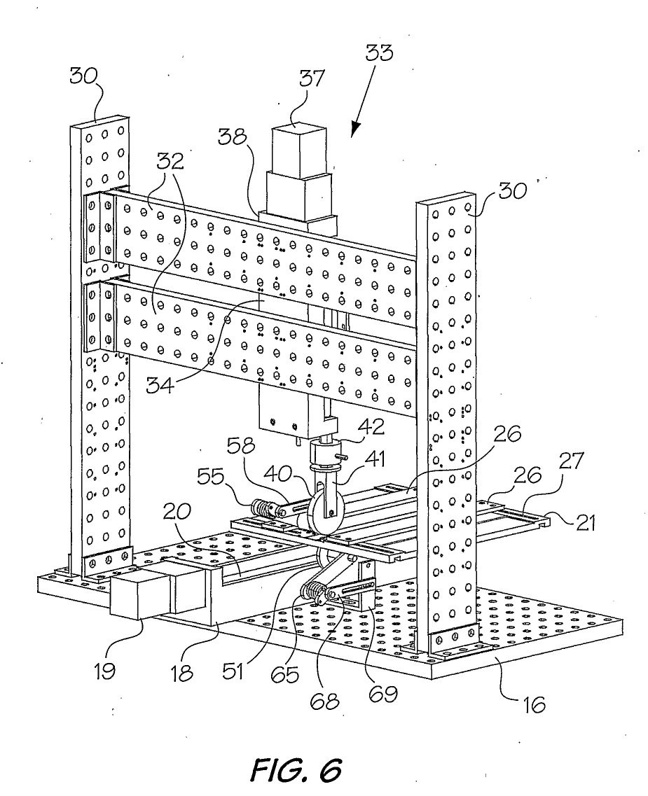

FIG. 6 is an isometric view of the apparatus of FIG. 5 as seen from the other side;

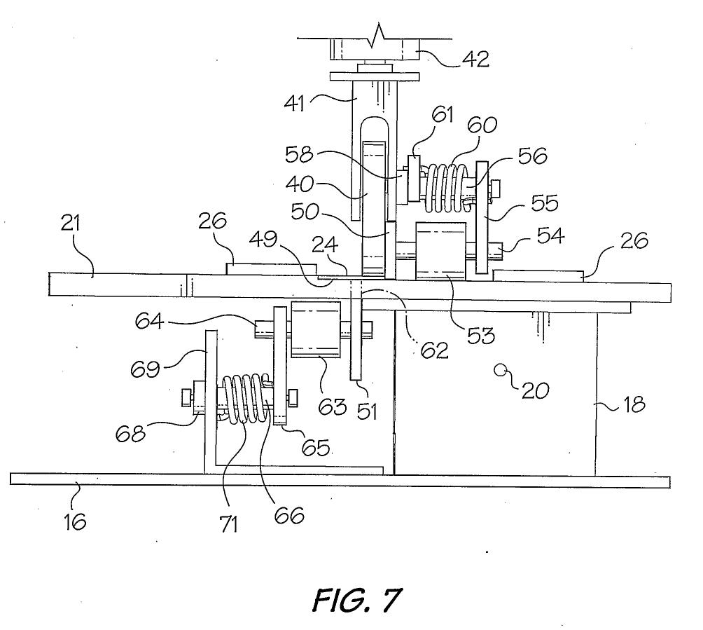

FIG. 7 is a schematic end view of the bottom portion of the apparatus of FIGS. 5 and 6;

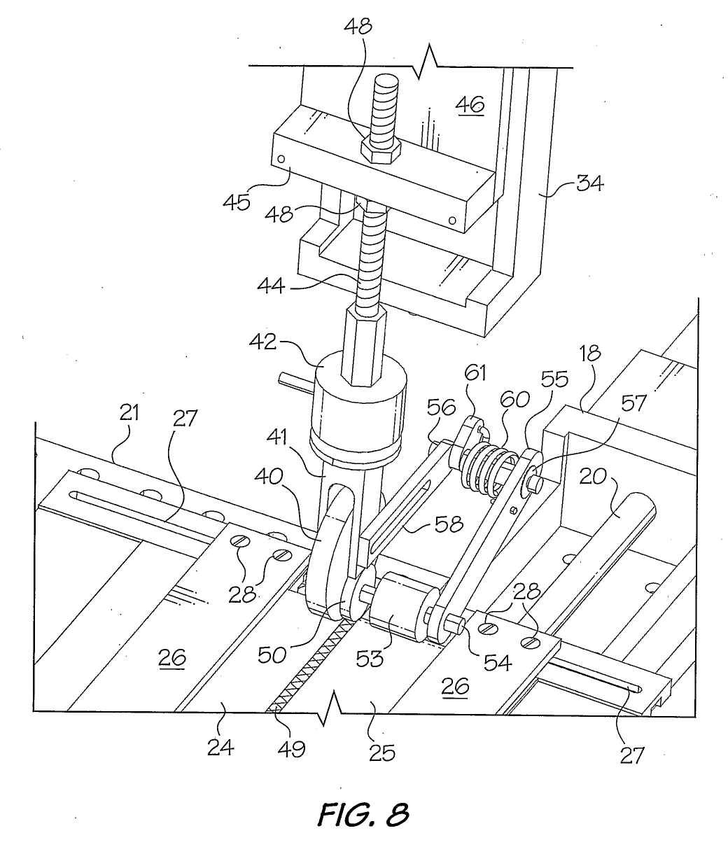

FIG. 8 is a schematic isometric view of a pressure roller assembly and an electrode mounting assembly used in the apparatus of FIGS. 5 and 6;

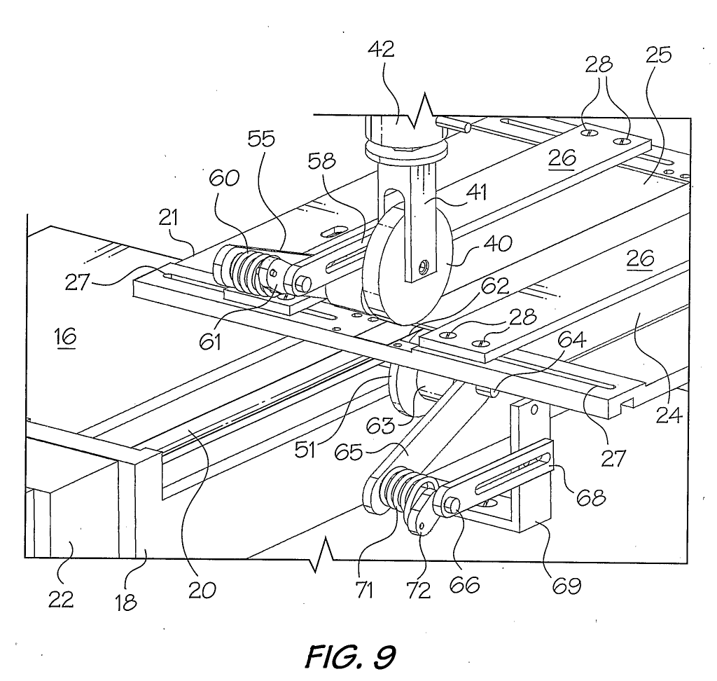

FIG. 9 is an isometric view of the pressure roller of FIG. 8 and two electrode mounting assemblies used in the apparatus of FIGS. 5 and 6;

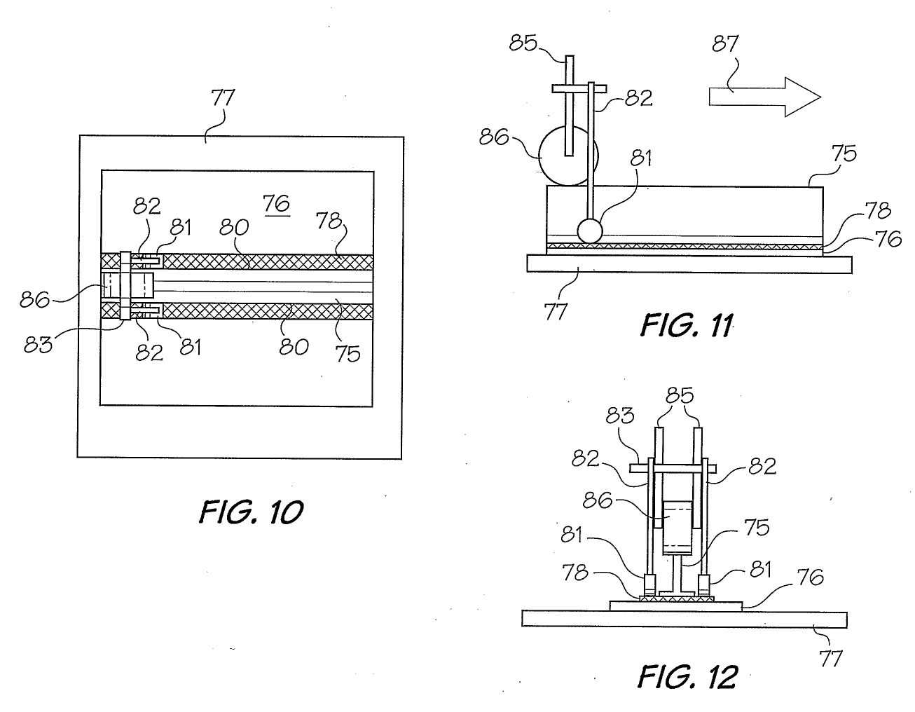

FIG. 10 is a schematic top view of a third embodiment of the apparatus of the invention;

FIG. 11 is a schematic side view of the apparatus of FIG. 10;

FIG. 12 is a schematic end view of the apparatus of FIG. 10;

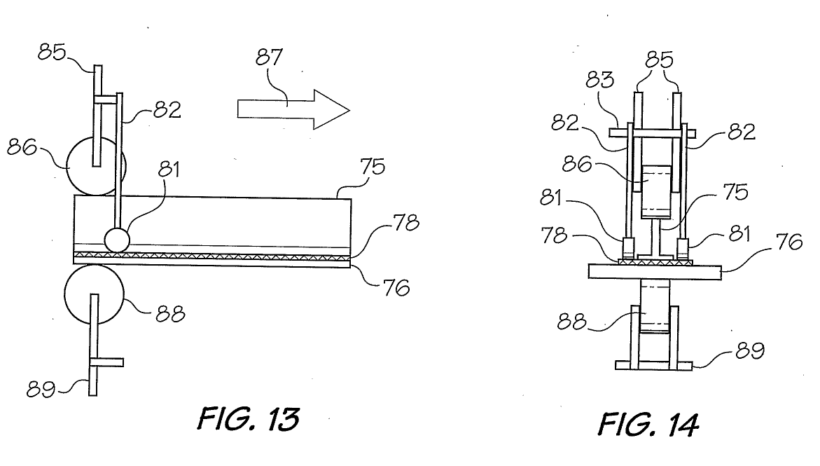

FIG. 13 is a schematic side view of a fourth embodiment of the apparatus in accordance with the invention; and

FIG. 14 is a schematic end view of the apparatus of FIG. 13.

Referring to FIGS. 1 to 3, a first embodiment of the apparatus of the present invention includes a baseplate 1 for supporting a pair of overlapping top and bottom layers 2 and 3, respectively of thermoplastic material with a resistance heating element 4 sandwiched between the layers 2 and 3. The heating element 4 extends laterally outwardly beyond the area of overlap between the layers 2 and 3 both beneath the top layer 2 and above the bottom layer 3. The layers 2 and 3 are composed, at least in part, of thermoplastic polymer film such as polypropylene (PP), polyetherimide (PEI) or polyetheretherketone (PEEK), and the heating element 4 is formed of a suitable electrically conductive material such as metal mesh or carbon fiber strips. Alternatively, the top and bottom layers may be a thermoplastic composite, in which case layers of neat thermoplastic material are provided between the top layer 2 and the heating element 4 and between the bottom layer 3 and the heating element 4. The heating element 4 may be embedded in the neat thermoplastic material or in the surface of one of the layers 2 and 3. Electrical power in the form of direct current is supplied to the heating element 4 via electrodes 5 and 6. The electrode 5 is in the form of a roller rotatably mounted on the bottom end of an inverted L-shaped support arm 7. The electrode 6 is used to ground the heating element 4. Other forms of electrodes such as a wire brush, a shoe or a knife can be used for supplying power to one side of the heating element 4. Alternatively, alternating current or pulsed current can be supplied to the heating element. The support arm 7 is connected to one end of a crossbar 8 extending between the sides 9 of a frame rotatably supporting a cylindrical compaction or pressure roller 10.

Welding of the layers 2 and 3 is effected by applying current to the electrode 5 while moving the electrode and the pressure roller 10 along the top layer 2 adjacent to the side edge 11 thereof above the weld area 12, which is roughly the same width as the roller 10. The use of a roller electrode 5 ahead of the pressure roller 10 in the direction of travel of the rollers creates localized heating of an area 13 (FIG. 4) in which the thermoplastic material becomes molten. The melt area 13 lies in front of a line of pressure applied by the pressure roller 10 which encourages even distribution of the melt, correcting for any unevenness of the heating and melting of the thermoplastic material, although the application of the electrical power across a minimum separation straddling the weld area typically ensures a relatively even melting of the thermoplastic material. As the pressure roller 10 passes over the area 13 in the direction of arrow 14, the layers 2 and 3 are fused to each other and to the heating element 4. Since the pressure and the electrical power level can be controlled, a consistent bond can be achieved without stopping the welding operation, i.e. in a continuous operation.

With reference to FIGS. 5 to 9, a second embodiment of the invention includes a baseplate 16 on which a drive assembly 17 is mounted. The assembly 17 is defined by a rectangular cross section housing 18 with an open top end. A drive member in the form of a motor and actuator 19 is mounted in one end of the housing 18. The shaft 20 of the motor and actuator 19 is fixedly connected to a slide (not shown), which carries a work table 21. The motor is reversible for moving the table 21 in two directions longitudinally of the housing 18. Instead of a motor and actuator, a hydraulic or pneumatic cylinder or a screw drive can be used.

The table 21 supports overlapping layers, in this case panels 24 and 25, formed of a thermoplastic composite during a welding procedure. The panels 24 and 25 are clamped in position on the table 21 by a pair of strips 26, which are slidably mounted for transverse movement on the table 21. Slots 27 in each end of the table 21 receive bolts 28, which permit sliding of the strips 26 transversely of the table. Nuts (not shown) beneath the table 21 are used to fix the strips 26 in position on the panels 24 and 25.

Posts 30 extending upwardly from the sides of the baseplate 16 support a pair of crossbars 32. A second drive assembly indicated generally at 33 is mounted on the crossbars 32. The assembly 33 includes a housing 34 (similar to the housing 18) with an open front end. The shaft 36 of a linear motor 37 mounted on the top end 38 of the housing 34 carries a slide 39 for effecting vertical movement at the slide. A compaction or pressure assembly is mounted on the slide 39. The pressure assembly includes a disc-shaped roller 40 rotatably mounted in a clevis 41 (FIGS. 6 to 9) for rolling on the overlapping edges, i.e. the weld area of the panels 24 and 25. The clevis 41 is suspended from a pressure gauge 42, which is carried by a threaded rod 44 extending upwardly through a bar 45 on the bottom end of a plate 46, which is connected to the slide 39. The pressure gauge 42 provides an indication of the pressure exerted by the roller 40 on the panels 24 and 25. The pressure gauge 42 may be connected to a control system (not shown) for controlling, inter alia, both pressure to the roller 40 and the rate of movement of the panels. The upper end of the rod 44 is retained in the bar 45 by nuts 48. By moving the slide 39 vertically in the housing 34, the pressure of the roller 40 on the weld area of the panels 24 and 25 can be changed.

When performing a welding operation, the composite panels 24 and 25 are placed on the table 21 with their sides in overlapping relationship. A heating element 49 in the form of a strip of metal mesh (FIGS. 7 and 8) is placed between the overlapping edges of the panels 24 and 25 in the weld area. The strip 49 extends outwardly beyond the side edges of the top and bottom panels 24 and 25, i.e. is exposed on the upper surface of the bottom panel 25 and the lower surface of the top panel 24. Top and bottom disc-shaped, electrodes 50 and 51, respectively are in constant contact with the strip 49 on opposite sides of the weld area. The top, positive electrode 50 is mounted on a cylinder 53, which is rotatably mounted on a shaft 54. The shaft 54 is fixedly mounted on the lower end of an inclined pivot arm 55. The upper end of the pivot arm 55 is rotatably mounted on one end of an axle 56 by means of a bearing 57 (FIG. 8). The other end of the axle 56 is fixedly mounted in the outer, free end of an arm 58, which extends outwardly from one side of the clevis 41.

One end of a coil spring 60 on the axle 56 is fixedly mounted in an ear 61 mounted on the axle 56, and the other end of the spring extends into the arm 55 beneath the bearing 57. Thus, the electrode 50 is biased downwardly against the heating element 49.

The second electrode 51 extends upwardly through a longitudinally extending slot 62 (FIGS. 7 and 9) in the table 21 into contact with the bottom of the heating element 49 on the opposite side of the pressure roller 40 from the electrode 50. The electrode 51 is rotatably mounted on a cylinder 63 which is rotatably mounted on a shaft 64. The other end of the shaft 64 is fixedly mounted on the top end of an inclined pivot arm 65. The bottom end of the pivot arm 65 is rotatably mounted on one end of an axle 66. The other end of the axle 66 is fixedly mounted in the outer free end of an arm 68 which extends outwardly from an L-bracket 69 on the baseplate 16. One end of a coil spring 71 on the axle 66 is fixedly mounted in an ear 72 extending outwardly from the axle 66 adjacent to the arm 68, and the other end of the spring extends into the arm 65 above the axle 66. Thus, the pivot arm 65 and consequently the roller electrode 51 are biased upwardly to maintain good contact between the bottom electrode 51 and the heating element 49.

FIGS. 10 to 12 illustrate a third embodiment of the invention which is intended to weld an inverted T-shaped rib 75 to a panel 76. The panel 76 is supported by a baseplate 77. A resistance heating element 78 is placed on the panel 76. The width of the element 78 is sufficient that the element extends outwardly beyond both side edges 80 of the rib 75. Electrical power is supplied to the heating element 78 via a pair of roller electrodes 81 during movement of the electrodes along the exposed sides of the heating element. The electrodes 81 are rotatably mounted on the bottom ends of inverted L-shaped support arms 82. The arms 82 are suspended from the ends of a crossbar 83 extending between the sides 85 of a frame, which supports a compaction or pressure roller 86.

During a welding operation, the two electrodes 81 advance along the exposed sides of the heating element 78. By supplying electrical current to the element 78, a weld area is created between the electrodes 81. The compaction roller 86, which follows the electrodes 81 in the direction of the arrow 87 (FIG. 11), presses the thermoplastic rib 75 against the heating element 78 and the panel 76 to fuse the rib and panel together. It will be appreciated that while the compaction roller 86 applies pressure to a top edge of the inverted-shaped rib 75, as an alternative or in addition pressure may be applied to a top of the base of the rib 75 by suitably modifying the shape or number of compaction rollers. Furthermore, a conformable shoe or other pressure application device may be used in other embodiments to provide pressure depending, inter alia, on topologies of the pieces to be joined, and the smoothness of the top surfaces of the piece to be joined.

The apparatus of FIGS. 13 and 14 is identical to the apparatus of FIGS. 10 to 12, except that the baseplate is replaced by a second compaction roller 88. The roller 88, which is vertically aligned with the roller 86, is rotatably mounted on a frame 89 which moves in unison with the roller 86 in the direction of the arrow 87. A pair of compaction rollers may be used in the situations in which high pressure is required.

The apparatuses described above can be used to weld most thermoplastic-based materials. The process is significantly faster than producing welds at overlapping areas in sequence, provides more consistent welds throughout long connections, and is simple, inexpensive and clean. Moreover, the process can be applied to large structures and to other topologies. The method described above permits continuous welding of overlapping portions of at least two thermoplastic or thermoplastic composite parts under well-controlled processing conditions. In the method welding occurs in a continuous gradual manner as opposed to welding the entire parts at once or welding individual segments of the weld one at a time. The system controls and provides excellent temperature distribution, minimizing discontinuities in the weld area. The production of the melt zone, and the power and pressure requirements for the system depend only on the width of the weld area and are independent from the length of weld area. These capabilities substantially increase the capacity of this process for welding large parts.

1. An apparatus for resistance welding of two thermoplastic articles comprising:
a support for supporting the articles in overlapping relationship;
a resistance heating element for positioning between said articles in an area of overlap along a length to be welded, said heating element having a width sufficient to span a weld area and extend outwardly beyond the area of overlap providing two exposed side edges of the heating element;
electrodes for connection to respective ones of said two side edges of said heating element;
a compactor for pressing said articles together in said weld area following melting of the articles to effect welding of the articles; and
a drive for moving at least one said electrode and compactor in synchronism relative to said articles along said weld area with said compactor behind at least one said electrode,
whereby said articles are pressed together in said weld area following melting of the articles to effect welding of the articles.

2. The apparatus of claim 1, wherein said electrode is a first roller for movement along said heating element, and said compactor includes a top compactor roller for movement along one said article for pressing said articles and said heating element together.

3. The apparatus of claim 2, wherein said support includes a baseplate for supporting said articles in overlapping relationship with the heating element therebetween.

4. The apparatus of claim 2, wherein said support includes a bottom compactor roller vertically aligned with said top compactor roller for movement relative to said articles in synchronism with said electrode and said top compactor roller.

5. The apparatus of claim 1, including a pair of electrodes for conducting electrical power to side edges of the heating element at locations adjacent to and spaced apart from said side edges of the articles, the electrodes being separated by a minimum distance straddling the weld area.

6. The apparatus of claim 5, wherein at least one of said articles is a panel and said heating element has sufficient width to extend outwardly beyond overlapping side edges of both of the articles.

7. The apparatus of claim 2, wherein said support includes a table for supporting said articles slidably mounted on said baseplate, and a frame on said baseplate for supporting said electrode.

8. The apparatus of claim 7, wherein said articles are panels for mounting in overlapping relationship on said table; and said electrodes include a top roller electrode for movement along an exposed side edge of said heating element above the table and adjacent to the weld area, and a second roller electrode for movement along an exposed side edge of the heating element beneath the table and adjacent to the weld area.

9. The apparatus of claim 8 including a first linear drive for moving said table horizontally with respect to said baseplate and frame; and a second linear drive for pushing said compactor downwardly against the top panel above the weld area.

10. A method of resistance welding two thermoplastic articles comprising the steps of:
placing a heating element between an overlapping area of said articles to define a weld area between overlapping side edges of the articles with the heating element extending outwardly beyond said side edges;
effecting relative movement between electrodes in contact with said heating element and the articles while applying current to the electrodes to effect localized heating of the weld area sufficient to create a moving, localized melt zone; and
applying pressure to said articles in the localized melt zone of the weld area immediately following creation of said localized melt zone to fuse the articles together.

11. The method of claim 10, wherein said articles are fixed in one position in overlapping relationship, and said electrode is moved along said weld area.

12. The method of claim 10, wherein said electrode is fixed in one position, and said articles and said heating element are moved relative to said electrode.

13. The method of claim 11, wherein said heating element extends outwardly beyond two side edges of the overlapping area, and a pair of electrodes are moved along exposed side edges of said heating element, the electrodes being separated by a minimum distance straddling the weld area.

14. The method of claim 13, wherein said electrodes are located in the same plane above the heating element.

15. The method of claim 11, wherein said heating element extends outwardly beyond two side edges of the overlapping area, whereby the heating element has exposed side edges above one article and below the second article; and electrodes are located above and below the heating element in contact with said exposed side edges.
